(19) United States
(12) Patent Application Publication
(10) Pub. No.: US 2021/0105321 A1
(43) Pub. Date: Apr. 8, 2021

(54) VEHICLE SOFTWARE CHECK

(71) Applicant: Ford Global Technologies, LLC, Dearborn, MI (US)

(72) Inventors: John P. Joyce, West Bloomfield, MI (US); Scott J. Lauffer, Northville, MI (US)

(73) Assignee: Ford Global Technologies, LLC, Dearborn, MI (US)

(21) Appl. No.: 16/595,764

(22) Filed: Oct. 8, 2019

(51) Int. Cl. H04L 29/08; G06F 21/62; H04L 9/06

(52) U.S. Cl. CPC H04L 67/1097; H04L 67/06; H04L 9/0643; G06F 21/6218; H04L 67/1095

(57) ABSTRACT

A system includes a computer. The computer includes a processor and a memory storing instructions executable by the processor to receive locally stored identifiers from each of a plurality of control modules of a vehicle; transmit a current list of the received locally stored identifiers to a remote server; receive a master list of compatible identifiers from the remote server, wherein each compatible identifier corresponds to a respective one of the control modules, and the master list includes file-verification data; prevent the vehicle from operating autonomously upon determining that one of the locally stored identifiers is different from the respective compatible identifier or upon determining that the file-verification data is incorrect; and permit the vehicle to operate autonomously upon determining that each locally stored identifier is the same as the respective compatible identifier and that the file-verification data is correct.

### BACKGROUND

Modern automobiles, especially vehicles capable of autonomous operation, typically include a plurality of electronic control units or modules (ECU). The ECUs are computers. A vehicle's computing tasks can be divided among the ECUs by function; a hybrid-powertrain control module can control a hybrid powertrain of the vehicle, a restraint control module can control airbags and pretensioners, and so on.

### BRIEF DESCRIPTION OF THE DRAWINGS

FIG. 1 is a block diagram of an example vehicle.

FIG. 2 is a process flow diagram of an example process for verifying the compatibility of control modules of the vehicle.

FIG. 3 is a time diagram of transmissions involving the vehicle and a remote server.

### DETAILED DESCRIPTION

The system described below improves the operation of a vehicle by controlling operation of software and hardware. The system can allow a fleet operator greater control over a fleet of vehicles. The system can improve vehicle efficiency and safety, and can ensure timely and correct maintenance for the vehicle by identifying hardware and by keeping software up to date and detecting a misinstallation, i.e., installing an incorrect version of software. The system can allow checks for proper identifiers to be performed by a control module that is on board the vehicle and that has a rating of a specified level, e.g., an Automotive Safety Integrity Rating (ASIL) of D, i.e., the highest rating. Advantageously, the system can minimize an amount of data transferred between the vehicle and a remote server.

The system includes a computer, and the computer includes a processor and a memory storing instructions executable by the processor to receive locally stored identifiers from at least one control module of a vehicle; transmit a current list of the received locally stored identifiers to a remote server; receive a master list of compatible identifiers from the remote server, wherein each compatible identifier corresponds to a respective one of the control modules, and the master list includes file-verification data; prevent the vehicle from operating autonomously upon determining that one of the locally stored identifiers is different from the respective compatible identifier or upon determining that the file-verification data is incorrect; and permit the vehicle to operate autonomously upon determining that each locally stored identifier is the same as the respective compatible identifier and that the file-verification data is correct.

The system may further include the remote server, and the remote server may store a plurality of possible master lists and may be programmed to, in response to receiving the current list, select one of the possible master lists as the master list, and then transmit the master list to the computer. The remote server may be further programmed to select one of the possible master lists as the master list based on an identifier of the vehicle.

The remote server may be further programmed to select one of the possible master lists as the master list based on the locally stored identifiers of the current list. The remote server may be further programmed to select as the master list the one of the possible master lists that includes the greatest number of compatible identifiers matching the locally stored identifiers of the current list.

The file-verification data may be one of a hash function or a checksum.

The master list may include a single compatible identifier for each control module.

Each locally stored identifier and each compatible identifier may include a first portion identifying a hardware version of the respective control module and a second portion identifying a software version of the respective control module. Each locally stored identifier and each compatible identifier may include a third portion identifying settings of the respective control module.

The current list may include locally stored identifiers corresponding to a plurality of control modules.

A method includes requesting, by a computer on board a vehicle, locally stored identifiers from at least one control module of the vehicle, wherein each locally stored identifier corresponds to a respective one of the control modules; transmitting, by the computer, a current list of the received locally stored identifiers to a remote server; receiving, by the computer, a master list of compatible identifiers from the remote server, wherein each compatible identifier corresponds to a respective one of the control modules, and the master list includes file-verification data; preventing, by the computer, the vehicle from operating autonomously upon determining that one of the locally stored identifiers is different from the respective compatible identifier or upon determining that the file-verification data is incorrect; and permitting, by the computer, the vehicle to operate autonomously upon determining both that each locally stored identifier is the same as the respective compatible identifier and that the file-verification data is correct.

The remote server may store a plurality of possible master lists, and the method may further include, by the remote server, in response to receiving the current list, selecting one of the possible master lists as the master list, and then transmitting the master list to the computer. The method may further include, by the remote server, selecting one of the possible master lists as the master list based on an identifier of the vehicle.

The method may further include, by the remote server, selecting one of the possible master lists as the master list based on the locally stored identifiers of the current list. The method may further include, by the remote server, selecting as the master list the one of the possible master lists that includes the greatest number of compatible identifiers matching the locally stored identifiers of the current list.

The file-verification data may be one of a hash function or a checksum.

The master list may include a single compatible identifier for each control module.

Each locally stored identifier and each compatible identifier may include a first portion identifying a hardware version of the respective control module and a second portion identifying a software version of the respective control module. Each locally stored identifier and each compatible identifier may include a third portion identifying settings of the respective control module.

The current list may include locally stored identifiers corresponding to a plurality of control modules.

With reference to the Figures, a system 32 for a vehicle 30 includes a computer 34. The computer 34 includes a processor and a memory storing instructions executable by the processor to receive locally stored identifiers from each of a plurality of control modules 36 of the vehicle 30; transmit a current list of the received locally stored identifiers to a remote server 38; receive a master list of compatible identifiers from the remote server 38, wherein each compatible identifier corresponds to a respective one of the control modules 36, and the master list includes file-verification data; prevent the vehicle 30 from operating autonomously upon determining that one of the locally stored identifiers is different from the respective compatible identifier or upon determining that the file-verification data is incorrect; and permit the vehicle 30 to operate autonomously upon determining that each locally stored identifier is the same as the respective compatible identifier and that the file-verification data is correct.

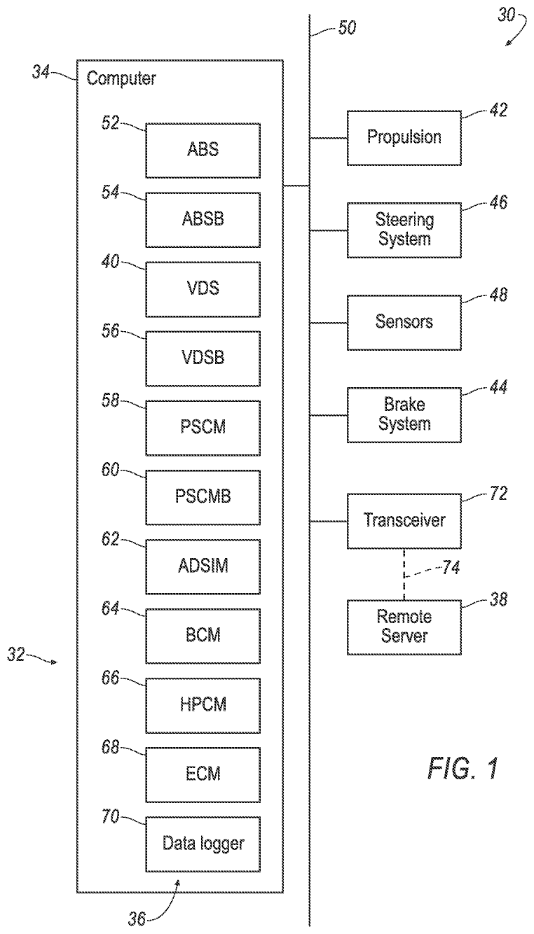

With reference to FIG. 1, the vehicle 30 may be any passenger or commercial automobile such as a car, a truck, a sport utility vehicle, a crossover, a van, a minivan, a taxi, a bus, etc.

The vehicle 30 may be an autonomous vehicle. A vehicle computer 40 can be programmed to operate the vehicle 30 independently of the intervention of a human driver, completely or to a lesser degree. The vehicle computer 40 may be programmed to operate a propulsion 42, a brake system 44, a steering system 46, and/or other vehicle systems, based at least in part on data received from sensors 48. The vehicle computer 40 may be able to switch between differing modes of autonomy, e.g., one or more autonomous modes and a nonautonomous mode. For the purposes of this disclosure, autonomous operation means the vehicle computer 40 controls the propulsion 42, brake system 44, and steering system 46 without input from a human driver; semi-autonomous operation means the vehicle computer 40 controls one or two of the propulsion 42, brake system 44, and steering system 46 and a human driver controls the remainder; and nonautonomous operation means a human driver controls the propulsion 42, brake system 44, and steering system 46. An autonomous mode means that the vehicle computer 40 provides autonomous or semi-autonomous operation. A nonautonomous mode means the vehicle computer 40 provides nonautonomous operation.

The vehicle computer 40 is a microprocessor-based computer. The vehicle computer 40 includes a processor, memory, etc. The vehicle computer 40 can be a single control module 36 or multiple control modules 36. The memory of the vehicle computer 40 includes memory for storing instructions executable by the processor as well as for electronically storing data and/or databases.

The computer 34 is one or more microprocessor-based computers. The computer 34 includes memory, at least one processor, etc. The memory of the computer 34 includes memory for storing instructions executable by the processor as well as for electronically storing data and/or databases. The computer 34 may be the same control module 36 as the vehicle computer 40, or the computer 34 may be one or more separate control modules 36 in communication with the vehicle computer 40 via a communications network 50, or the computer 34 may encompass multiple control modules 36 including the vehicle computer 40.

The control modules 36 are sometimes referred to as electronic control units or modules (ECUs or ECMs). The control modules 36 are a plurality of distinct microprocessor-based computers. The control modules 36 each include a processor, memory, etc. The memory of each control module 36 includes media for storing instructions executable by the respective processor as well as for electronically storing data and/or databases. The control modules 36 include a first antilock-brake control module 52, a second antilock-brake control module 54, the vehicle computer 40, a backup vehicle computer 56, a first power-steering control module 58, a second power-steering control module 60, an automated-driving-system interface module 62, a body control module 64, a hybrid-powertrain control module 66, an engine control module 68, and/or a data logger 70. The computer 34 can be any one or a combination of those control modules 36.

Each control module 36 has a locally stored identifier corresponding to that control module 36. For the purposes of this disclosure, “identifier” is defined as a label substantially unique to a version of a component, and “locally stored” is defined as stored in memory on board the vehicle 30. The locally stored identifier can be stored in the memory of the corresponding control module 36. Each locally stored identifier can include a first portion, a second portion, and/or a third portion. The first portion identifies a hardware version of the respective control module 36. The second portion identifies a software version of the respective control module 36, i.e., of a program, application, operating system, etc. running on the respective control module 36. The third portion identifies settings of the respective control module 36, e.g., for stability control, antilock braking, etc. The first, second, and third portions can be stored separately.

Some of the control modules 36 have an ASIL D rating. Automotive Safety Integrity Level (ASIL) is a risk classification scheme defined by ISO 26262. ASIL has four levels of risk, A, B, C, and D, in ascending order. The control modules 36 subject to ASIL D can be the vehicle computer 40, the first antilock-brake control module 52, the second antilock-brake control module 54, the backup vehicle computer 56, the first power-steering control module 58, and the second power-steering control module 60. The computer 34 can specifically be one or more of the ASIL D-rated control modules.

The computer 34 may transmit and receive data through the communications network 50, which can be a controller area network (CAN) bus, Ethernet, WiFi, Local Interconnect Network (LIN), onboard diagnostics connector (OBD-II), and/or by any other wired or wireless communications network. The computer 34 may be communicatively coupled to the control modules 36, the propulsion 42, the brake system 44, the steering system 46, the sensors 48, a transceiver 72, and other components via the communications network 50.

The propulsion 42 of the vehicle 30 generates energy and translates the energy into motion of the vehicle 30. The propulsion 42 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion 42 can include a control module 36, e.g., the hybrid-powertrain control module 66, that is in communication with and receives input from the vehicle computer 40 and/or a human driver. The human driver may control the propulsion 42 via, e.g., an accelerator pedal and/or a gear-shift lever.

The steering system 46 is typically a conventional vehicle steering subsystem and controls the turning of the wheels. The steering system 46 may be a rack-and-pinion system with electric power-assisted steering, a steer-by-wire system, as both are known, or any other suitable system. The steering system 46 can include a control module 36, e.g., the first power-steering control module 58 and/or second power-steering control module 60, that is in communication with and receives input from the vehicle computer 40 and/or a human driver. The human driver may control the steering system 46 via, e.g., a steering wheel.

The brake system 44 is typically a conventional vehicle braking subsystem and resists the motion of the vehicle 30 to thereby slow and/or stop the vehicle 30. The brake system 44 may include friction brakes such as disc brakes, drum brakes, band brakes, etc.; regenerative brakes; any other suitable type of brakes; or a combination. The brake system 44 can include a control module 36, e.g., the first antilock-brake control module 52 and/or second antilock-brake control module 54, that is in communication with and receives input from the vehicle computer 40 and/or a human driver. The human driver may control the brake system 44 via, e.g., a brake pedal.

The sensors 48 may provide data about operation of the vehicle 30, for example, wheel speed, wheel orientation, and engine and transmission data (e.g., temperature, fuel consumption, etc.). The sensors 48 may detect the location and/or orientation of the vehicle 30. For example, the sensors 48 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 48 may detect the external world, e.g., objects and/or characteristics of surroundings of the vehicle 30, such as other vehicles, road lane markings, traffic lights and/or signs, pedestrians, etc. For example, the sensors 48 may include radar sensors, scanning laser range finders, light detection and ranging (LIDAR) devices, and image processing sensors such as cameras.

The transceiver 72 is adapted to transmit signals wirelessly through any suitable wireless communication protocol, such as Bluetooth®, WiFi, IEEE 802.11a/b/g, other RF (radio frequency) communications, etc. The transceiver 72 is adapted to communicate with a remote server 38, that is, a server distinct and spaced from the vehicle 30. The transceiver 72 may be one device or may include a separate transmitter and receiver.

The remote server 38 is located outside the vehicle 30. For example, the remote server 38 may be associated with another vehicle (e.g., V2V communications), an infrastructure component (e.g., V2I communications via Dedicated Short-Range Communications (DSRC) or the like), an emergency responder, a mobile device associated with the owner of the vehicle 30, etc. In particular, the remote server 38 can be associated with a fleet manager for the vehicle 30. The remote server 38 can include a server and a data store.

The transceiver 72 can connect to the remote server 38 through a network 74. The network 74 represents one or more mechanisms by which the computer 34 may communicate with the remote server 38. Accordingly, the network 74 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The remote server 38 stores a plurality of possible master lists. Each possible master list includes compatible identifiers corresponding to the control modules 36. For the purposes of this disclosure, “compatible identifier” is defined as a possible identifier for a control module 36, indicating that the control module 36 is up-to-date and compatible with the other control modules 36. Each compatible identifier corresponds to a respective control module 36. Each compatible identifier can include a first portion, a second portion, and/or a third portion. The first portion identifies a hardware version of the respective control module 36. The second portion identifies a software version of the respective control module 36, i.e., of a program, application, operating system, etc. running on the respective control module 36. The third portion identifies settings of the respective control module 36, e.g., for stability control, antilock braking, etc. The first, second, and third portions can be stored separately. For each possible master list, each compatible identifier in that possible master list indicates a control module 36 that is compatible with the control module 36 for every other compatible identifier on the possible master list.

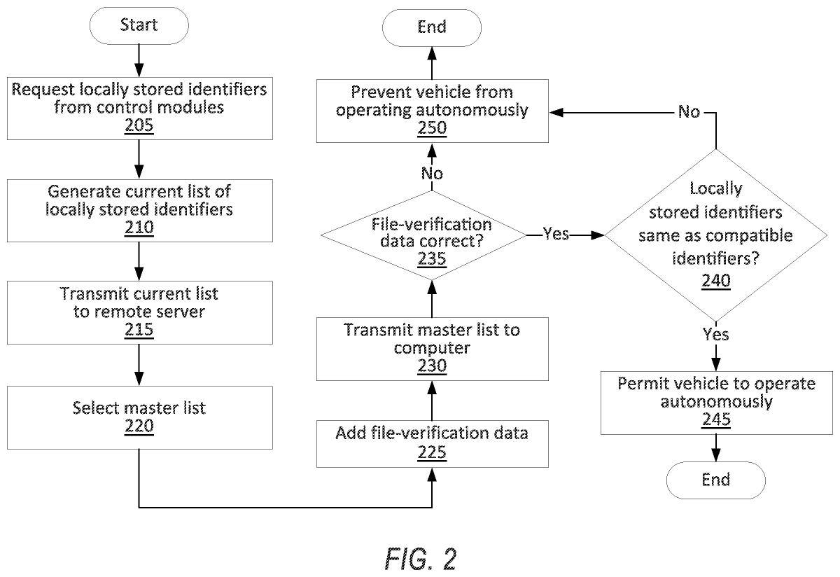

FIG. 2 is a process flow diagram illustrating an exemplary process 200 for verifying the compatibility of the control modules 36 of the vehicle 30. The memories of the computer 34 and of the remote server 38 store executable instructions for performing the steps of the process 200. As a general overview of the process 200, the computer 34 generates and transmits a current list of the locally stored identifiers to the remote server 38; the remote server 38 transmits a master list of compatible identifiers corresponding to the locally stored identifiers; and the computer 34 permits the vehicle 30 to operate autonomously if the master list matches the current list and prevents the vehicle 30 from operating autonomously if file-verification data in the master list is incorrect or if the master list does not match the current list.

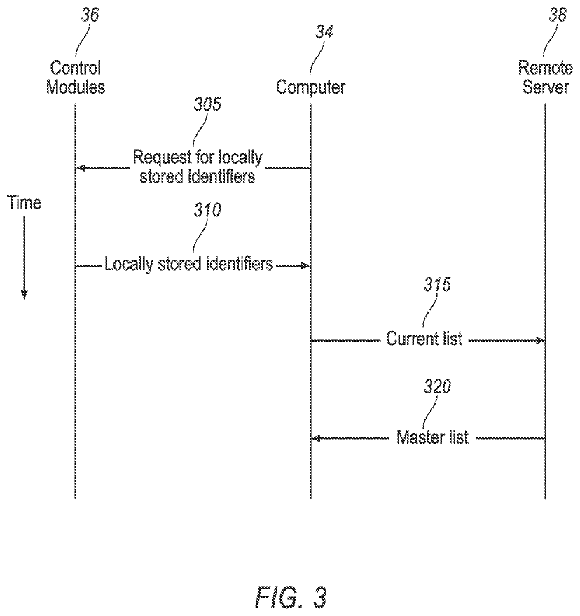

The process 200 begins in a block 205, in which the computer 34 sends requests 305 to the control modules 36 for the locally stored identifiers via the communications network 50, as shown in FIG. 3.

Next, in a block 210, the computer 34 receives the locally stored identifiers 310 from the control modules 36, as shown in FIG. 3, and generates the current list. The current list contains a single locally stored identifier for each control module 36 of all the control modules 36 or for each control module 36 of a subset of control modules 36. The subset of control modules 36 can be chosen according to safety-criticality, e.g., by an ASIL rating being at or above a specified level.

Next, in a block 215, the computer 34 transmits the current list 315 to the remote server 38 via the communications network 50 and the transceiver 72, and the remote server 38 receives the current list 315 via the network 74, as shown in FIG. 3. The computer 34 can also transmit an identifier of the vehicle 30, e.g., an identifier that indicates a make, model, and year of the vehicle 30, or a vehicle-identification number (VIN) indicating the particular vehicle 30.

Next, in a block 220, the remote server 38 selects one of the possible master lists as the master list 320 in response to receiving the current list 315. For example, the remote server 38 can select the master list 320 based on the identifier of the vehicle 30. The remote server 38 can store a table with pairings of identifiers of vehicles (or portions of the identifiers of the vehicles) with the possible master lists. The remote server 38 can select as the master list 320 the possible master list corresponding with the identifier of the vehicle 30 in the table. For another example, the remote server 38 can select the master list 320 based on the locally stored identifiers of the current list. In particular, the remote server 38 can select as the master list 320 the possible master list that includes the greatest number of compatible identifiers matching the locally stored identifiers of the current list 315, i.e., the greatest number of compatible identifiers that are the same as the respective locally stored identifiers of the current list 315.

In the block 225, the remote server 38 adds file-verification data to the master list 320. Alternatively, the master list 320 selected from the possible master lists can already include the file-verification data. The file-verification data permits the computer 34 to check for corruption of the master list 320 from being transmitted from the remote server 38 to the computer 34. For example, the file-verification data can be one of a hash function or a checksum. A hash function maps data of arbitrary size onto data of fixed size. A checksum is a small-sized datum derived from a block of data in a predictable manner. The master list 320 includes a compatible identifier for each control module 36 from the block 220 and file-verification data from the block 225.

Next, in a block 230, the remote server 38 transmits the master list 320 to the computer 34 via the network 74, and the computer 34 receives the master list 320 via the transceiver 72 and the communications network 50, as shown in FIG. 3.

Next, in a decision block 235, the computer 34 determines whether the file-verification data is correct. For example, the computer 34 calculates the hash function, checksum, etc. from the master list 320 and determines whether the result of the calculation matches the file-verification data included as part of the master list 320. If the file-verification data is incorrect, the process 200 proceeds to a block 250. If the file-verification data is correct, the process 200 proceeds to a decision block 240.

In the decision block 240, the computer 34 determines whether each locally stored identifier on the current list 315 is the same as the respective compatible identifier on the master list 320; i.e., for each control module 36, the computer 34 determines whether the locally stored identifier on the current list 315 is the same as or different than the compatible identifier on the master list 320. Whether a locally stored identifier is the same or different than the respective compatible identifier may be determined by string matching. Upon determining that each locally stored identifier is the same as the respective compatible identifier, the process 200 proceeds to a block 245. Upon determining that one of the locally stored identifiers is different from the respective compatible identifier, the process 200 proceeds to the block 250.

In the block 245, the computer 34 permits the vehicle 30 to operate autonomously. The computer 34 can send a message to the vehicle computer 40 indicating that the vehicle computer 40 is allowed to enter the autonomous mode and to command the propulsion 42, steering system 46, and brake system 44. After the block 245, the process 200 ends.

In the block 250, the computer 34 prevents the vehicle 30 from operating autonomously. The computer 34 can send a message to the vehicle computer 40 indicating that the vehicle computer 40 is prohibited from entering the autonomous mode and preventing the vehicle computer 40 from commanding the propulsion 42, steering system 46, and brake system 44. After the block 250, the process 200 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. The adjectives “first,” “second,” and “third” are used throughout this document as identifiers and are not intended to signify importance, order, or quantity.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A system comprising a computer, wherein the computer comprises a processor and a memory storing instructions executable by the processor to:
receive locally stored identifiers from at least one control module of a vehicle that includes the computer;
transmit a current list of the received locally stored identifiers to a remote server;
receive a master list of compatible identifiers from the remote server, wherein each compatible identifier corresponds to a respective one of the control modules, and the master list includes file-verification data and includes a single compatible identifier for each control module;
determine whether any of the locally stored identifiers is different from the respective compatible identifier on the master list;
prevent the vehicle from operating autonomously upon determining that one of the locally stored identifiers is different from the respective compatible identifier or upon determining that the file-verification data is incorrect; and
permit the vehicle to operate autonomously upon determining that each locally stored identifier is the same as the respective compatible identifier and that the file-verification data is correct.

2. The system of claim 1, further comprising the remote server, wherein the remote server stores a plurality of possible master lists and is programmed to, in response to receiving the current list, select one of the possible master lists as the master list, and then transmit the master list to the computer.

3. The system of claim 2, wherein the remote server is further programmed to select one of the possible master lists as the master list based on an identifier of the vehicle.

4. The system of claim 2, wherein the remote server is further programmed to select one of the possible master lists as the master list based on the locally stored identifiers of the current list.

5. The system of claim 4, wherein the remote server is further programmed to select as the master list the one of the possible master lists that includes the greatest number of compatible identifiers matching the locally stored identifiers of the current list.

6. The system of claim 1, wherein the file-verification data is one of a hash function or a checksum.

7. (canceled)

8. The system of claim 1, wherein each locally stored identifier and each compatible identifier includes a first portion identifying a hardware version of the respective control module and a second portion identifying a software version of the respective control module.

9. The system of claim 8, wherein each locally stored identifier and each compatible identifier includes a third portion identifying settings of the respective control module.

10. The system of claim 1, wherein the current list includes locally stored identifiers corresponding to a plurality of control modules.

11. A method comprising:
receiving, by a computer on board a vehicle, locally stored identifiers from at least one control module of the vehicle, wherein each locally stored identifier corresponds to a respective one of the control modules;
transmitting, by the computer, a current list of the received locally stored identifiers to a remote server;
in response to receiving the current list, selecting, by the remote server, one of a plurality of possible master lists stored on the remote server as the master list, and then transmitting the master list to the computer, wherein the master list includes a single compatible identifier for each control module, and compatible identifiers in the master list indicate respective corresponding control modules compatible with respective control modules for other compatible identifiers on the master list;
receiving, by the computer, a master list of compatible identifiers from the remote server, wherein each compatible identifier corresponds to a respective one of the control modules, and the master list includes file-verification data;
preventing, by the computer, the vehicle from operating autonomously upon determining that one of the locally stored identifiers is different from the respective compatible identifier or upon determining that the file-verification data is incorrect; and
permitting, by the computer, the vehicle to operate autonomously upon determining both that each locally stored identifier is the same as the respective compatible identifier and that the file-verification data is correct.

12. (canceled)

13. The method of claim 11, further comprising, by the remote server, selecting one of the possible master lists as the master list based on an identifier of the vehicle.

14. The method of claim 11, further comprising, by the remote server, selecting one of the possible master lists as the master list based on the locally stored identifiers of the current list.

15. The method of claim 14, further comprising, by the remote server, selecting as the master list the one of the possible master lists that includes the greatest number of compatible identifiers matching the locally stored identifiers of the current list.

16. The method of claim 11, wherein the file-verification data is one of a hash function or a checksum.

17. (canceled)

18. The method of claim 11, wherein each locally stored identifier and each compatible identifier includes a first portion identifying a hardware version of the respective control module and a second portion identifying a software version of the respective control module.

19. The method of claim 18, wherein each locally stored identifier and each compatible identifier includes a third portion identifying settings of the respective control module.

20. The method of claim 11, wherein the current list includes locally stored identifiers corresponding to a plurality of control modules.
